(19) United States
(12) Patent Application Publication
(10) Pub. No.: US 2010/0111497 A1
(43) Pub. Date: May 6, 2010

(54) MEDIA PLAYING TOOL WITH A MULTIPLE MEDIA PLAYING MODEL

(76) Inventors: Zhikai Song, Shanghai (CN); Yong Zhang, Shanghai (CN); Ji Bai, Shanghai (CN)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/440,404

(22) PCT Filed: Sep. 6, 2006
(86) PCT No.: PCT/CN06/02302

§ 371 Date: Nov. 20, 2009

(51) Int. Cl. H04N 7/00

(52) U.S. Cl. 386/95; 386/E05.003

(57) ABSTRACT

Machine-readable media, methods, and apparatus are described for a media playing tool with a multiple media playing model. In some embodiments, the multiple media playing model may decoding a first media stream into a plurality of first frames and decode a second media stream into a plurality of second frames. Further, the multiple media playing model may adjust a first frame of the plurality of first frames and a second frame of the plurality of second frames into a third frame with a predetermined layout.

### BACKGROUND

Conventionally, a media playing tool of a computing platform may play one media content at one time. In order to play another media content, the media playing tool may have to close the content that is already in play. If an end user desires to view different media contents at same time, the end user may open different media playing tools or open additional instances of the same media playing tool. Each media playing tool or each media playing instance may play each of the media contents. In such case, the end user may have to rearrange the media contents manually in order to view the multiple media contents simultaneously.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a system having a host platform and a client platform.

FIG. 2 illustrates an embodiment of the host platform having a media playing tool.

FIG. 3 illustrates an embodiment of the client platform.

FIG. 4a illustrates an embodiment of a multiple media playing model of the media playing tool.

FIG. 4b illustrates an embodiment of a single-media playing model of the media playing tool.

FIG. 5 illustrates an embodiment of a method of playing multiple media streams and/or a single media stream.

### DETAILED DESCRIPTION OF THE PREFERRED EMBODIMENTS

The following description describes techniques for a media playing tool with a multiple media playing model. In the following description, numerous specific details such as logic implementations, pseudo-code, methods to specify operands, resource partitioning/sharing/duplication implementations, types and interrelationships of system components, and logic partitioning/integration choices are set forth in order to provide a more thorough understanding of the current invention. However, the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium that may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.) and others.

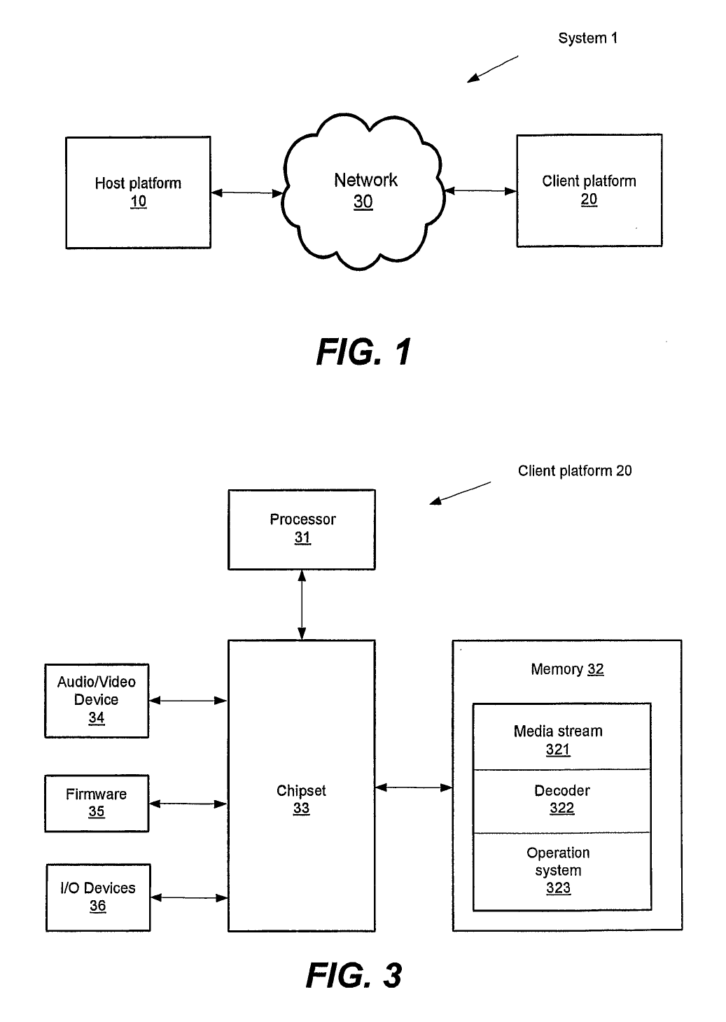

FIG. 1 shows an embodiment of a system 1. The system 1 may comprise a host platform 10 and a client platform 20 that may connect with the host platform 10 through a network 30, such as Ethernet, fiber channel, wireless connection, or possibly other communication links. The host platform 10 may process a single media stream at one time or may process multiple media streams simultaneously. The processed single media stream or the processed multiple media streams may be played back at the host platform 10 or may be transmitted to and played back at the client platform 20. Examples of the host platform 10 may comprise mainframe computer, mini-computer, personal computer, portable computer, laptop computer and other devices for transceiving and processing data. Examples of the client platform 20 may comprise a digital media adapter coupled to a play unit (e.g., a television), and possibly other devices for transceiving and processing data.

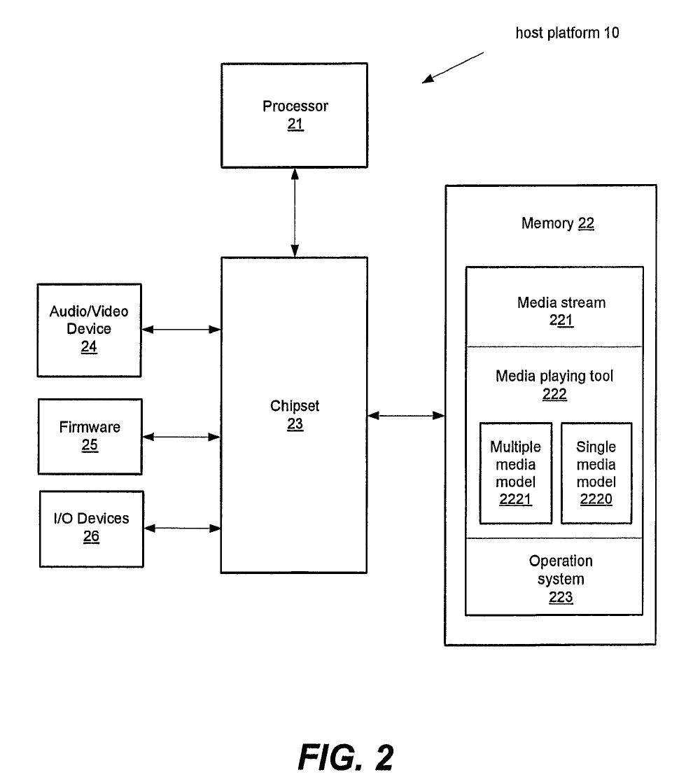

FIG. 2 illustrates an embodiment of the host platform 10. The host platform 10 may comprise one or more processors 21, memory 22, chipset 23, audio/video device 24, firmware 25, I/O devices 26 and possibly other components. One or more processors 21 may be communicatively coupled to various components (e.g., the chipset 23) via one or more buses such as a processor bus. Processors 21 may be implemented as an integrated circuit (IC) with one or more processing cores that may execute codes under a suitable architecture, for example, including Intel® Pentium™, Intel® Itanium™, Intel® Core™ Duo architectures, available from Intel Corporation of Santa Clara, Calif.

Memory 22 may store instructions and data in the form of media stream 221, a media playing tool 222 and an operation system 223. Examples for memory 22 may comprise one or any combination of the following semiconductor devices, such as synchronous dynamic random access memory (SDRAM) devices, RAMBUS dynamic random access memory (RDRAM) devices, double data rate (DDR) memory devices, static random access memory (SRAM), and flash memory devices.

Media stream 221 may be input from any suitable devices, such as I/O devices 26. In other embodiments, media stream 221 may also be generated by other components within host platform 10. Media stream 221 may take the form of a single media stream or multiple media streams.

Media playing tool 222 may run between media stream 221 and operating system 223 to process media stream 221 either to be played at host platform 10 or to be transmitted to and played at client platform 20. Media playing tool 222 may comprise a single media playing model 2220 and a multiple media playing model 2221.

If media stream 221 is a single media stream, single media playing model 2220 may decode the single media stream into frames and render the decoded frames according to a format and a resolution supportable by video/audio device 24 of host platform 10, so that the rendered frames may be played at host platform 10. Alternatively, single media playing model 2220 may trans-code the single media stream according to a format supportable by client platform 20 if the format of the single media stream (e.g., MPEG 2) is different from the format supportable by client platform 20 (e.g., MPEG 4). Single media playing model 2220 may further trans-rate the single media stream according to the status of network 30 (e.g., whether the network bandwidth is limited or not), so that the single media stream may be transmitted from host platform 10 to client platform 20 at a bit rate suitable for the network status.

If media stream 221 is multiple media streams and is to be played at host platform 10, multiple media playing model 2221 may decode the multiple media streams into multiple groups of frames. Multiple media playing model 2221 may further render the multiple groups of decoded frames not only according to a resolution supportable by video/audio device 24 of host platform 10, but also according to a predetermined playback layout so that video/audio device 24 may simultaneously play the multiple media streams in the predetermined layout. The predetermined playback layout may be provided by any parties, such as an end user of host platform 10 or a manufacturer of host platform 10.

The predetermined playback layout may define the positional relationship among frames of the multiple media streams that may be played simultaneously in a single frame. The single frame may comprise a plurality of sub-frames, and each of the sub-frames may correspond to each of the multiple frames from the multiple media stream. Therefore, the predetermined playback layout may further define resolution of each sub-frame of the single frame. For example, the playback layout may define that two sub-frames corresponding to two frames from two media streams are played simultaneously with equal resolution and in side-by-side position.

If the media stream 221 is multiple media streams and is to be transmitted to and played at client platform 20, multiple media playing model 2221 may decode the multiple media streams into multiple groups of frames, render the multiple groups of decoded frames not only according to a resolution supportable by a video/audio device of client platform 20, but also according to a predetermined playback layout so that the video/audio device of client platform 20 may simultaneously play the multiple media streams in the predetermined layout. The predetermined playback layout may be provided by any parties, such as an end user of client platform 20 or a manufacturer of client platform 20. The predetermined playback layout may define the positional relationship among frames of the multiple media streams that may be played back simultaneously in a single frame. The single frame may comprise a plurality of sub-frames, and each sub-frame may correspond to each frame from each media stream. Therefore, the predetermined playback layout may further define resolution of each sub-frame of the single frame.

In such case, multiple media playing model 2221 may further encode the rendered frames according to a format supportable by client platform 20 and according to a bit rate suitable for the network status, so that the encoded frames may be transmitted to and played at client platform 20.

Chipset 23 may provide one or more communicative paths among one or more processors 21, memory 22 and other components, such as audio/video device 24, firmware 25 and I/O devices 26.

Firmware 25 that may store BIOS routines that host platform 10 executes during system startup in order to initialize processors 21, chipset 23, and other components of host platform 10 and/or EFI routines to interface firmware 25 with an operating system of host platform 10 and provide a standard environment for booting operating system 223.

I/O devices 26 may input or output data to or from host system 10. Examples for I/O devices 26 may comprise a network card, a blue-tooth, an antenna, and possibly other devices for transceiving data.

FIG. 3 may illustrate an embodiment of client platform 20. Client platform 20 may comprise one or more processors 31, memory 32, chipset 33, audio/video device 34, firmware 35, I/O devices 36 and possibly other components, One or more processors 31 may be communicatively coupled to various components (e.g., the chipset 33) via one or more buses such as a processor bus. Processors 31 may be implemented as an integrated circuit (IC) with one or more processing cores that may execute codes under a suitable architecture, for example, including Intel® Pentium™, Intel® Itanium™, Intel® Core™ Duo architectures, available from Intel Corporation of Santa Clara, Calif.

Memory 32 may store instructions and data in the form of media stream 321, a decoder 322 and an operation system 323. Examples for memory 32 may comprise one or any combination of the following semiconductor devices, such as synchronous dynamic random access memory (SDRAM) devices, RAMBUS dynamic random access memory (RDRAM) devices, double data rate (DDR) memory devices, static random access memory (SRAM), and flash memory devices.

Media stream 321 may be received from host platform 10 via I/O devices 36. Decoder 322 may run between the media stream 221 and operating system 323 to decode media stream 221 so as to be played at client platform 20. Operation system 323 may include, but is not limited to, different versions of Linux®, Microsoft® Windows®, and real time operating systems such as VxWorks®, etc.

Chipset 33 may provide one or more communicative paths among one or more processors 31, memory 32 and other components, such as audio/video device 34, firmware 35, and I/O devices 34.

Firmware 35 that may store BIOS routines that client platform 20 executes during system startup in order to initialize processors 31, chipset 33, and other components of client platform 20 and/or EFI routines to interface firmware 35 with an operating system of client platform 20 and provide a standard environment for booting operating system 323.

I/O devices 36 may input or output data to or from client system 20. Examples for I/O devices 36 may comprise a network card, a blue-tooth, an antenna, and possibly other devices for transceiving data.

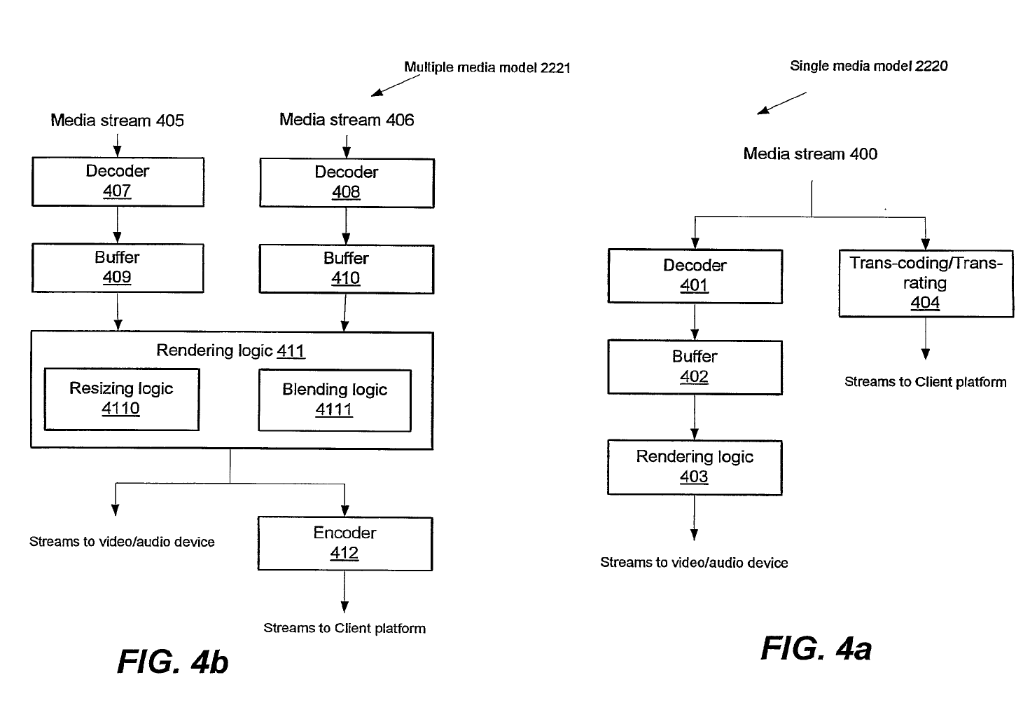

FIG. 4a may illustrate an embodiment of single media playing tool 2220.

As illustrated, single media playing tool 2220 may comprise a decoder 401, a buffer 402, a rendering logic 403 and a trans-coding/trans-rating logic 404. Decoder 401, buffer 402 and rendering logic 403 may work for media playback at host platform 10. Trans-coding/trans-rating logic 404 may work for media playback at client platform 20.

More specifically, decoder 401 may decode a single media stream 400 into a number of frames. Buffer 402 may temporarily store the decoded frames. Rendering logic 403 may adjust the decoded frames to be playable by video/audio device 24 of host platform 10. For example, rendering logic 403 may adjust the decoded frames according to a resolution supportable by video/audio device 24 of host platform 10.

Trans-coding/trans-rating logic 404 may trans-code single media stream 400 according to a format supportable by client platform 20, if the format of single media stream 400 (e.g., MPEG 2) is different from the format supportable by client platform 20 (e.g., MPEG 4). Trans-coding/trans-rating logic 404 may further trans-rate single media stream 400 according to the network status, so that single media stream 400 may be transmitted from host platform 10 to client platform 20 at a bit rate suitable for the network status.

FIG. 4b may illustrate an embodiment of multiple media playing tool 2221.

As illustrated, multiple media playing model 2221 may comprise decoder 407, decoder 408, buffer 409, buffer 410, rendering logic 411 and encoder 412. Decoder 407 and buffer 409 may work for frame decoding of a media stream 405, and decoder 408 and buffer 410 may work for frame decoding of another media stream 406. Although FIG. 4b illustrates two media streams, it should be appreciated that multiple media playing model 2221 may comprise any numbers of decoders and buffers to process any numbers of media streams.

Decoder 407 and decoder 408 may respectively decode media stream 405 and media stream 406 into frames. Buffer 409 and buffer 410 may respectively temporarily store decoded frames from decoder 407 and decoder 408.

Rendering logic 411 may render the decoded frames of media stream 405 and media stream 406 not only according to a resolution supportable by video/audio device 24 of host platform 10 or by video/audio device 34 of client platform 20, but also according to a predetermined playback layout, so that the multiple media streams may be simultaneously played at host platform 10 or at client platform 20. The predetermined playback layout may define positional relationship of multiple frames from multiple media streams 405-406 that may be played in a single frame. The predetermined playback layout may further define resolution of each sub-frame of the single frame, and the each sub-frame may correspond to each frame from each media stream.

Rendering logic 411 may comprise a resizing logic 4110 and a blending logic 4111. Resizing logic 4110 may analyze the single frame in the predetermined layout and determine a resolution of each sub-frame of the single frame. For example, the predetermined layout may define that the single frame may comprise two sub-frames with equal resolution and the two sub-frames may be played side-by-side. The two sub-frames may respectively correspond to two decoded frames from media stream 405 and media stream 406. Resizing logic 4110 may resize a decoded frame retrieved from a buffer if the resolution of the decoded frame is different from the resolution of its corresponding sub-frame in the predetermined layout.

Blending logic 4111 may blend two frames from the resizing logic 4110 according to the positional relationship of the sub-frames of the single frame. For example, if the predetermined layout defines to play a single frame with two sub-frames side-by-side, blending logic 4111 may simply retrieve array data from each resized frame and copy the array data to the corresponding position in the single frame.

The rendered frame, namely, the single frame, may be forwarded to video/audio device 24 of host platform 10 so as to be played at host platform 10. However, the rendered frame may be further forwarded to encoder 412 that may encode the single frame according to a format supportable by client platform 20, and/or according to a bit rate suitable for the network status. Then, the encoded frames of multiple media streams 405-406 may be transmitted to and played at client platform 20.

Other embodiment may implement other technologies for multiple media playing tool 2221. In an embodiment, resizing logic 4110 may not resize each decoded frame from each media stream. For example, the predetermined playback layout may define that two decoded frames from two media streams are simultaneously played in a single frame with an embedding-embedded positional relationship. In such case, the single frame may comprise one sub-frame, in which the sub-frame may be embedded within the single frame (e.g., a sub-frame is played at the right-lower corner of the single frame). Then, resizing logic 4110 may only need to resize a decoded frame from a media stream that correspond to the sub-frame, while leaving another decoded frame from another media stream that correspond to the single frame unchanged.

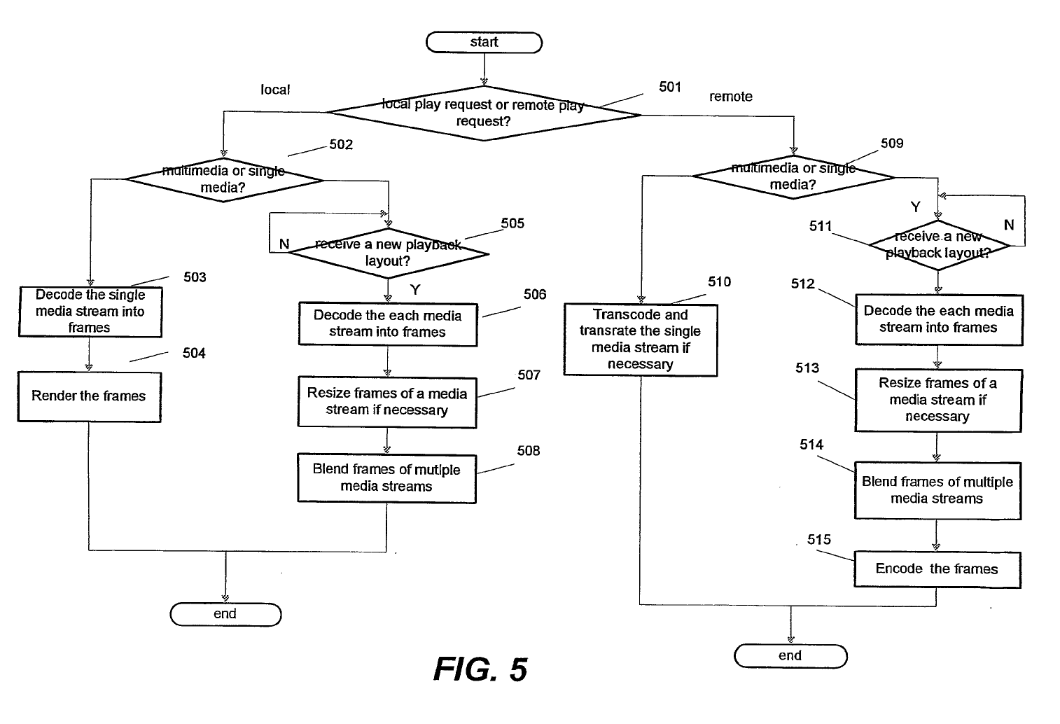

FIG. 5 illustrates an embodiment of a method of playing multiple media streams and/or a single media stream.

In block 501, media playing tool 221 of host platform 10 may determine whether a playback request is from host platform 10 (i.e., local play request) or from client platform 20 (i.e., remote play request). For the local play request, media playing tool 221 may determine whether media stream 221 is a single media stream or multiple media streams in block 502.

If media stream 221 is the single media stream, single media playing model 2220 may process the single media stream in blocks 503-504. In block 503, decoder 401 of single media playing model 2220 may decode the single media stream into frames. In block 504, rendering logic 403 of single media playing model 2220 may render the decoded frames according to a format and/or resolution supportable by video/audio device 24 of host platform 10, so that host platform 10 may play the single media stream.

If media stream 221 is the multiple media streams, multiple media playing model 2221 may process the multiple media streams in blocks 505-508, so that host platform 10 may playback the multiple media streams simultaneously in a single frame. In block 505, rendering logic 411 of multiple media playing model 2221 may determine whether it have received a playback layout. The rendering logic 411 may receive the playback layout from various parties, such as ender user of the host platform 10, end user of client platform 20, or default layout predefined by a manufacturer. The playback layout may define positional relationship of multiple frames that may be played simultaneously in a single frame, in which each of the multiple frames is from each of the multiple media streams. The single frame may comprise multiple sub-frames and each sub-frame may correspond to a frame from a media stream. The playback layout may further define resolution of each sub-frame.

Then, in block 506, decoders 407 and 408 of multiple media playing model 2221 may decode each of the multiple media streams into frames. In block 507, resizing logic 4110 may analyze the resolution of each sub-frame and resize a decoded frame of a media stream if the resolution of the decoded frame is different from the resolution of its corresponding sub-frame. In block 508, blending logic 4111 may blend frames from the resizing logic 4110 into the single frame according to positional relationship defined by the layout, so that host platform 10 may play the single frame in the predetermined layout.

If media playing tool 222 determines the play request is from client platform 20 (i.e., a remote play request) in block 501, then media playing tool 222 may determine whether media stream 221 is a single media stream or multiple media streams in block 509. If media stream 221 is the single media stream, then in block 510, trans-coding/trans-rating logic 404 of single media playing model 2220 may trans-code the single media stream according to a format supportable by video/audio device 34 of client platform 20 if the format of the single media stream (e.g., MPEG 2) is different from the format supportable by client platform 20 (e.g., MPEG 4). In block 510, trans-coding/trans-rating logic 404 may further trans-rate the single media stream according to the network status (e.g., whether the network bandwidth is limited or not), so that the single media stream may be transmitted from host platform 10 to client platform 20 at a bit rate suitable for the network status.

If media stream 221 is multiple media streams, then multiple media playing model 2221 may process the multiple media streams in blocks 511-515.

In block 511, rendering logic 411 of multiple media playing model 2221 may determine whether it have received a playback layout. The playback layout may define positional relationship of multiple frames that may be played simultaneously in a single frame. Each of the multiple frames is retrieved from each of the multiple media streams. The single frame may comprise multiple sub-frames and each sub-frame may correspond to a frame from a media stream. The playback layout may further define resolution of each sub-frame.

Then, in block 512, decoders 407 and 408 of multiple media playing model 2221 may decode each of the multiple media streams into frames. In block 513, resizing logic 4110 may analyze the resolution of each sub-frame and resize a decoded frame from a media stream if the resolution of the decoded frame is different from the resolution of its corresponding sub-frame. In block 514, blending logic 4111 may blend frames from the resizing logic 4110 into the single frame according to positional relationship defined by the layout. In block 515, encoder 412 of multiple media playing model 2221 may encode the single frame according to a format supportable by client platform 20, and/or according to a bit rate suitable for the network status. Then, the encoded frames of the multiple media streams may be transmitted to and played at client platform 20.

Other embodiments may implement other technologies on the method as illustrated in FIG. 5. In an embodiment, the playback layout may be updated during the media play process. For example, the end user of client platform 20 may require changing the current playback layout with a new playback layout. Then, client platform 10 may transmit the new playback layout to host platform 10. The multiple media playing model 2221 may analyze the new playback layout and render the multiple media streams based upon the new playback layout.

Although the present invention has been described in conjunction with certain embodiments, it shall be understood that modifications and variations may be resorted to without departing from the spirit and scope of the invention as those skilled in the art readily understand. Such modifications and variations are considered to be within the scope of the invention and the appended claims.

What is claimed is:

1. A method for a media playing tool of a computing platform, comprising:
decoding a first media stream into a plurality of first frames;
decoding a second media stream into a plurality of second frames; and
adjusting a first frame of the plurality of first frames and a second frame of the plurality of second frames into a third frame with a predetermined layout.

2. The method of claim 1, wherein the third frame comprises a first sub-frame and a second sub-frame and the predetermined layout defines at least one of a positional relationship between the first sub-frame and the second sub-frame, a first resolution of the first sub-frame, and a second resolution of the second sub-frame.

3. The method of claim 2, wherein the adjusting further comprises:
resizing the first frame to generate a resized first frame based upon the first resolution of the first sub-frame;
resizing the second frame to generate a resized second frame based upon the second resolution of the second sub-frame; and
blending the resized first frame with the resized second frame based upon the positional relationship.

4. The method of claim 1, wherein the third frame comprise a sub-frame and the predetermined layout defines at least one of a positional relationship between the third frame and the sub-frame and a resolution of the sub-frame.

5. The method of claim 4, wherein the adjusting further comprises:
resizing the second frame to generate a resized second frame based upon the resolution of the sub-frame; and
blending the first frame with the resized second frame based upon the positional relationship.

6. The method of claim 1, further comprising:
encoding the third frame to be transmitted to another computing platform.

7. The method of claim 1, further comprising:
playing the third frame at the computing platform.

8. A media playing tool of a computing platform, comprising:
a first decoder to decode a first media stream into a plurality of first frames;
a second decoder to decode a second media stream into a plurality of second frames; and
an adjusting logic to adjust a first frame of the plurality of first frames and a second frame of the plurality of second frames into a third frame with a predetermined layout.

9. The media playing tool of claim 8, wherein the third frame comprises a first sub-frame and a second sub-frame and the predetermined layout defines at least one of a positional relationship between the first sub-frame and the second sub-frame, a first resolution of the first sub-frame and a second resolution of the second sub-frame.

10. The media playing tool of claim 9, wherein the adjusting logic further comprises a resizing logic to resize the first frame to generate a resized first frame based upon a first resolution of the first sub-frame and resize the second frame to generate a resized second frame based upon a second resolution of the second sub-frame.

11. The media playing tool of claim 10, wherein the adjusting logic further comprises a blending logic to blend the resized first frame with the resized second frame based upon the positional relationship.

12. The media playing tool of claim 8, wherein the third frame comprises a sub-frame, and the predetermined layout defines at least one of a positional relationship between the third frame and the sub-frame and a resolution of the sub-frame.

13. The media playing tool of claim 12, wherein the adjusting logic further comprises a resizing logic to resize the second frame to generate a resized second frame based upon a second resolution of the second sub-frame.

14. The media playing tool of claim 13, wherein the adjusting logic further comprises a blending logic to blend the first frame with the resized second frame according to the positional relationship.

15. The media playing tool of claim 8, further comprising an encoder to encode the third frame to be transmitted to another computing platform.

16. A computing platform, comprising:
a processor;
a machine-accessible medium responsive to the processor; and
instructions in the machine accessible medium, wherein the instructions, when executed by the system, cause the computing platform to perform operations comprising:
decoding a first media stream into a plurality of first frames;
decoding a second media stream into a plurality of second frames; and
adjusting a first frame of the plurality of first frames and a second frame of the plurality of second frames into a third frame with a predetermined layout.

17. The computing platform of claim 16, wherein the third frame comprises a first sub-frame and a second sub-frame and the predetermined layout defines at least one of a positional relationship between the first sub-frame and the second sub-frame, a first resolution of the first sub-frame and a second resolution of the second sub-frame.

18. The computing platform of claim 17, wherein the operation of adjusting, comprises:
resizing the first frame to generated a resized first frame based upon the first resolution of the first sub-frame.
resizing the second frame to generate a resized second frame based upon the second resolution of the second sub-frame; and
blending the resized first frame with the resized second frame based upon the positional relationship.

19. The computing platform of claim 16, wherein the third frame comprise a sub-frame, and the predetermined layout defines at least one of a positional relationship between the third frame and the sub-frame and a resolution of the sub-frame.

20. The computing platform of claim 19, wherein the operation of adjusting, comprises:
resizing the second frame to generate a resized second frame based upon the second resolution of the second sub-frame; and
blending the first frame with the resized second frame based upon the positional relationship.

21. The computing platform of claim 16, wherein the instructions cause the computing platform to perform operations comprising:
encoding the third frame to be transmitted to another computing platform.

22. A machine-readable medium comprising a plurality of instructions which when executed result in a computing platform:
decoding a first media stream into a plurality of first frames;
decoding a second media stream into a plurality of second frames; and
adjusting a first frame of the plurality of first frames and a second frame of the plurality of second frames into a third frame with a predetermined layout.

23. The machine-readable medium of claim 22, wherein the third frame comprises a first sub-frame and a second sub-frame and the predetermined layout defines at least one of a positional relationship between the first sub-frame and the second sub-frame, a first resolution of the first sub-frame and a second resolution of the second sub-frame.

24. The machine-readable medium of claim 23, wherein the plurality of instructions that result in the computing platform adjusting, further result in the computing platform:
resizing the first frame to generate a resized first frame based upon the first resolution of the first sub-frame;
resizing the second frame to generate a resized second frame based upon the second resolution of the second sub-frame; and
blending the resized first frame with the resized second frame based upon the positional relationship.

25. The machine-readable medium of claim 22, wherein the third frame comprise a sub-frame, and the predetermined layout defines at least one of a positional relationship between the third frame and the sub-frame and a resolution of the sub-frame.

26. The machine-readable medium of claim 25, wherein the plurality of instructions that result in the computing platform adjusting, further result in the computing platform:
resizing the second frame to generate a resized second frame based upon the second resolution of the second sub-frame; and
blending the first frame with the resized second frame based upon the positional relationship.

27. The machine-readable medium of claim 22, wherein the plurality of instructions further result in the computing platform:
encoding the third frame to be transmitted to another computing platform.
